(19) United States
(12) Patent Application Publication
(10) Pub. No.: US 2014/0083456 A1
(43) Pub. Date: Mar. 27, 2014

(54) METHOD AND APPARATUS FOR SUBSTRATE EDGE CLEANING

(71) Applicant: Corning Incorporated, Corning, NY (US)

(72) Inventors: Mitchell Jerome Ramsey, Barton, NY (US); Siva Venkatachalam, Painted Post, NY (US); Liming Wang, Painted Post, NY (US)

(73) Assignee: Corning Incorporated, Corning, NY (US)

(21) Appl. No.: 13/627,358

(22) Filed: Sep. 26, 2012

(51) Int. Cl. B08B 7/04; B08B 7/02; B08B 3/04; B08B 1/02

(52) U.S. Cl. CPC B08B 7/04; B08B 1/02; B08B 7/026; B08B 3/04
USPC 134/9; 15/21.1

(57) ABSTRACT

Disclosed herein are methods and apparatuses for cleaning at least one edge of a substrate. Exemplary methods and apparatuses include a cleaning system comprising (a) a plurality of fluid channels, (b) a plurality of brushes, (c) at least one nozzle, and (d) at least one vibration generator. The brushes may comprise a plurality of bristles and/or nodules and may be connected to at least one of the fluid channels such that fluid flows through the bristles and/or nodules to the substrate edge. At least one vibration generator may be connected to the cleaning system and configured to deliver sonic energy to the plurality of brushes.

### FIELD OF THE DISCLOSURE

The disclosure relates generally to methods and apparatuses for cleaning at least one edge of a substrate. Exemplary methods include conveying the substrate edge across a cleaning system comprising (a) a plurality of fluid channels, (b) a plurality of brushes, (c) at least one nozzle, and (d) at least one vibration generator connected to the cleaning system. According to various embodiments, the brushes may comprise a plurality of bristles and/or nodules and may be connected to at least one of the fluid channels such that fluid flows through the bristles and/or nodules to the substrate edge.

### BACKGROUND

Consumer demand for high-performance display devices, such as liquid crystal and plasma displays, has grown markedly in recent years due to the exceptional display quality, decreased weight and thickness, low power consumption, and increased affordability of these devices. Such high-performance display devices can be used to display various kinds of information, such as images, graphics, and text.

High-performance display devices typically employ one or more substrates, such as a glass substrate. The surface quality requirements for substrates have become more stringent as the demand for improved resolution and image performance increases. The surface quality may be influenced by any of the processing steps, from forming the substrate to final packaging.

One processing step that may result in surface contamination is the beveling process, wherein a rectangular edge of the substrate is ground and polished to impart a beveled edge. The resulting beveled edge may contain within it and/or on it, a large number of particles, such as small particles in the micron and submicron range. These particles may be present on the beveled edge with varying degrees of attachment and/or adhesion and have the potential to migrate to the surface at any time. The potential of particles to migrate to the surface during subsequent processing steps, product transportation, and/or customer processing, causes concerns with the surface quality of the substrate. However, current manufacturing methods do not include an effective technology for cleaning or removing such particles from the substrate edge.

Various potential methods for dealing with migratory particles on the substrate edge may include, for example, polishing the edge to a high degree, cleaning the edge after substrate processing, and/or coating the edge to prevent particle migration. However, processing the substrate edge to produce a highly polished edge can be expensive and time-consuming, and coating the edge to prevent particle migration can introduce additional surface contamination. Thus, there is a need in the industry for methods of cleaning a substrate edge after grinding and/or polishing the substrate to minimize, or even eliminate, particles present on the substrate edge.

### SUMMARY

The disclosure relates, in various embodiments, to methods and apparatuses for cleaning, e.g., removing particles from at least one edge of a substrate. According to one embodiment, the method for cleaning at least one substrate edge comprises conveying the substrate edge across a cleaning system comprising (a) a plurality of fluid channels disposed within the cleaning system for delivering at least one fluid to the substrate edge, (b) a plurality of brushes comprising a plurality of bristles and/or nodules and connected to at least one of the plurality of fluid channels, (c) at least one nozzle disposed within the cleaning system, and (d) at least one vibration generator, connected to the cleaning system and disposed to deliver sonic energy to at least one of the plurality of brushes. In certain embodiments, the substrate edge is contacted with the plurality of brushes and the fluid for a time sufficient to remove particles from the substrate edge.

A further embodiment of the disclosure relates to an apparatus for cleaning at least one edge of a substrate, the apparatus comprising a cleaning system comprising (a) a plurality of fluid channels disposed within the cleaning system for delivering at least one fluid to the substrate edge, (b) a plurality of brushes comprising a plurality of bristles and/or nodules and connected to at least one of the plurality of fluid channels, (c) at least one nozzle disposed within the cleaning system, and (d) at least one vibration generator, connected to the cleaning system and disposed to deliver sonic energy to at least one of the plurality of brushes.

The substrate may, for example, include a first surface and a second surface substantially parallel to the first surface, and an edge comprising a first bevel, second bevel, and apex disposed between the first and second bevels. According to various embodiments of the disclosed methods and apparatuses, the plurality of brushes may be configured so as to contact at least the first bevel, the second bevel, and the apex of the substrate edge. The substrate may also comprise a first bevel-surface interface, defined by the region where the first surface and first bevel sections meet, and a second bevel-surface interface, defined by the region where the second surface and second bevel sections meet. According to further embodiments of the disclosed methods and apparatuses, the plurality of brushes may be configured so as to contact at least the first bevel-surface interface, the first bevel, the second bevel-surface interface, the second bevel, and the apex of the substrate edge.

Additional features and advantages will be set forth in the detailed description which follows, and in part will be readily apparent to those skilled in the art from the description or recognized by practicing the embodiments as described in the written description and claims hereof, as well as the appended drawings. It is to be understood that both the foregoing general description and the following detailed description are merely exemplary, and are intended to provide an overview or framework to understand the nature and character of the claims.

### BRIEF DESCRIPTION OF THE DRAWINGS

The accompanying drawings are included to provide a further understanding of the disclosure, and are incorporated in and constitute a part of this specification. The drawings illustrate one or more exemplary embodiments and, together with the description, serve to explain the principles and operation of the various embodiments.

FIG. 1 is a side view of an exemplary substrate edge.

FIG. 2 is a side view of one embodiment of a cleaning system according to the disclosure.

FIG. 3 is a top view of another embodiment of a cleaning system according to the disclosure.

FIG. 4 is a top view of a further embodiment of a cleaning system according to the disclosure.

FIG. 5 is a top view of yet another embodiment of a cleaning system according to the disclosure.

### DETAILED DESCRIPTION

According to various embodiments of the disclosure, at least one edge of a substrate may be cleaned by bringing the substrate edge into contact with a cleaning system. For example, the substrate edge may be conveyed across the cleaning system such that the plurality of brushes comes into contact with at least the first and second bevels and the apex of the substrate edge. In other embodiments, the plurality of brushes may contact at least the first and second bevel-surface interfaces, the first and second bevels, and the apex of the substrate.

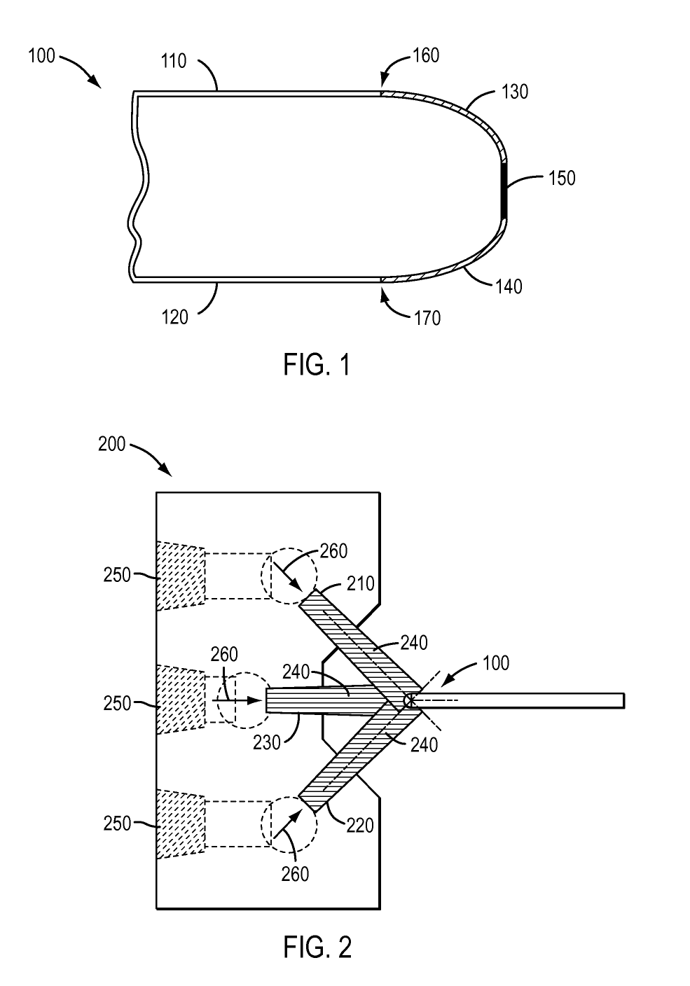

Referring to FIG. 1, which illustrates an exemplary substrate edge 100, the term “first surface,” and other variations thereof, is used herein to denote a first, relatively flat region of the substrate. The first surface is denoted by 110 in FIG. 1. Similarly, the term “second surface,” and other variations thereof, is used herein to denote a second, relatively flat region of the substrate, which is substantially parallel to the first surface. The second surface is denoted by 120 in FIG. 1.

The terms “first bevel,” “first bevel section,” and other variations thereof, are used herein to denote a first portion of the substrate edge, located between the first surface and the apex. The first bevel is denoted by 130 in FIG. 1. Similarly, the terms “second bevel” and “second bevel section” and other variations thereof are used herein to denote a second portion of the substrate edge, located between the second surface and the apex. The second bevel is denoted by 140 in FIG. 1. In certain embodiments, the first and second bevels may be curved, as shown in FIG. 1; however, the first and second bevels may, in other non-limiting embodiments, be relatively flat.

The term “apex,” and other variations thereof, is used herein to denote the end region of the substrate edge, where the first and second bevels converge. It is noted that FIG. 1 depicts the apex as a flat area having a given length; however the apex can also be a finite point where the first and second bevels meet, such that the substrate edge is a substantially continuous curve. The apex is denoted by 150 in FIG. 1.

The term “first bevel-surface interface,” and other variations thereof, is used herein to denote the region where the first bevel section meets the relatively flat first surface. The first bevel-surface interface is denoted by 160 in FIG. 1. Similarly, the term “second bevel-surface interface,” and other variations thereof, is used herein to denote the region where the second bevel section meets the relatively flat second surface. The second bevel-surface interface is denoted by 170 in FIG. 1.

The methods and apparatuses of the instant disclosure may be employed to clean the edge of any substrate. In one embodiment, the substrate may be a glass substrate, such as a glass panel for use in a high-performance display device. However, other embodiments may also relate to substrates useful in other contexts, such as semiconductor substrates or any other substrate on which wiring patterns are to be formed, or any other substrate useful in other applications that are sensitive to fine particles. According to certain embodiments, the substrate may have a thickness of less than about 6 mm, for example, from about 1 mm to about 2.5 mm, or from about 0.1 mm to about 0.7 mm.

The at least one substrate edge may, in various embodiments, be conveyed across a cleaning system. As used herein, the terms “convey,” “conveyed,” and other variations thereof, are intended to denote any motion whereby either (a) a substrate edge is brought into contact with a stationary cleaning system and moved along the length of the cleaning system or (b) a cleaning system is brought into contact with a stationary substrate and moved along the length of the substrate edge, or (c) a non-stationary substrate edge is brought into contact with a non-stationary cleaning system. In all cases, the substrate is conveyed across the cleaning system such that the plurality of brushes contacts at least the first bevel, the second bevel, and the apex of the substrate edge.

The substrate may be conveyed across the cleaning system at any angle relative to the cleaning system. For example, the substrate may be conveyed horizontally or vertically, or at any other angle, so long as the plurality of brushes comes into contact with at least the first bevel, the second bevel, and the apex of the substrate edge.

The substrate may be conveyed across the cleaning system at any speed suitable to effectuate cleaning of the substrate edge. For instance, the substrate may be conveyed at a speed ranging from about 1 to about 25 meters per minute. In other embodiments, the substrate may be conveyed at a speed ranging from about 3 to about 8 meters per minute, such as from about 6 to about 10 meters per minute, or from about 15 to about 22 meters per minute.

The cleaning system of the instant disclosure may comprise, inter alia, a plurality of fluid channels, disposed within the cleaning system and configured to deliver at least one fluid to the substrate edge. As used herein, the term “fluid channel” is intended to denote any conduit by which a fluid can travel to the substrate edge by any means. The fluid channels may, in certain embodiments, be connected to at least one fluid source or reservoir, configured so as to contain and supply the fluid to the substrate edge via the fluid channels. In further embodiments, the fluid channels may be connected to one or more pumps operable to transport fluid from the reservoir to the substrate edge via the fluid channels. Alternatively, the fluid channels may operate by way of gravity or any other means capable of promoting fluid flow through the channels to the substrate edge.

As used herein, the term “fluid” is intended to denote any fluid suitable for cleaning a substrate edge, such as solvents and/or cleaning fluids. The fluid may, for example, be chosen from water, deionized water, surfactant solutions, acids, bases, and combinations thereof. In various exemplary embodiments, the bases may have a pH ranging from about 9 to about 13, and may be chosen from, for example, ammonium hydroxide (NH₄OH), tetramethylammonium hydroxide (TMAH), potassium hydroxide (KOH), and sodium hydroxide (NaOH). Suitable acids include, but are not limited to, acids with a pH ranging from about 1 to about 3, such as hydrofluoric acid (HF), hydrochloric acid (HCl), and citric acid. Without wishing to be bound by theory, it is believed that acidic and basic fluids may have increased cleaning efficacy due to the high degree of repulsion between the particles and the substrate. The repulsion is due to positively charged particles in a highly acidic environment or negatively charged particles in a highly basic environment.

The at least one fluid may, in certain embodiments, be delivered to the cleaning interface at room temperature and ambient pressure. However, in other embodiments at least one nozzle may be connected to at least one of the plurality of fluid channels. The nozzle may operate, for example, as a spray jet, delivering the fluid at elevated pressures. In one embodiment, the fluid may be delivered at a pressure ranging from about 0.1 MPa to about 5 MPa, for example, from about 0.1 MPa to about 0.8 MPa, or from about 1 MPa to about 3 MPa. The presence of at least one nozzle delivering the fluid at an elevated pressure may serve to move the particles away from the substrate edge, thereby reducing the potential for contamination of the substrate surface. In yet further embodiments, the at least one fluid may be heated before delivery to the cleaning interface. For example, the at least one fluid may be heated to a temperature ranging from about 20° C. to about 90° C., such as from about 40° C. to about 75° C. The heated fluid may be delivered via the fluid channels through the brushes and/or nozzles connected to the channels.

According to various non-limiting embodiments, the fluid channels may be configured so as to deliver more than one fluid to the substrate edge. For example, the plurality of fluid channels may be connected to more than one fluid reservoir, each containing a different fluid. By way of non-limiting example, a fluid channel connected to a brush may deliver a first fluid, e.g., water, whereas a fluid channel connected to a nozzle may deliver a second fluid, e.g., an acid, base, or surfactant solution, or vice versa. In other embodiments, all fluid channels disposed within the cleaning system may deliver the same fluid to the substrate edge. It is within the ability of one skilled in the art to select an appropriate fluid, or combinations of fluids, according to the desired application.

The cleaning system of the instant disclosure may comprise, inter alia, a plurality of brushes. As used herein, the terms “brush,” “brushes,” “plurality of brushes,” and variations thereof, are intended to denote a plurality of bristles and/or nodules which, upon contact with the substrate, provide some degree of cleaning by removing at least one particle through one or more mechanical actions, e.g., scrubbing, scraping, displacing, and/or vibrating, etc. The bristles and/or nodules may, in certain embodiments, be composed of polyvinyl acetate (PVA), nylon, mohair, urethane foam, and/or any other porous or sponge-like material. The bristles and/or nodules of a brush may be oriented such that they are substantially parallel to one another. In other non-limiting embodiments, the bristles and/or nodules of a brush may extend radially from the brush at a given angle or a number of different angles. The bristles and/or nodules may be of any length, for example, from about 5 mm to about 50 mm, or from about 10 mm to about 30 mm. In certain embodiments, the brushes may comprise bristles and/or nodules having different lengths.

The brushes are configured within the cleaning system so as to be connected to at least one of the plurality of fluid channels. The cleaning action of the brushes may be further enhanced by the action of at the least one fluid delivered via the fluid channels. For example, any number of the plurality of fluid channels may have a brush connected thereto such that the fluid flows through the bristles and/or nodules of the brush to the substrate edge. Without wishing to be bound by theory, it is believed that this configuration may help keep the bristles and/or nodules clean so as to decrease the aggregation of particles therein and promote flushing of the particles away from the substrate edge.

According to various embodiments, the plurality of brushes comprises at least one first brush, at least one second brush, and at least one third brush. The at least one first brush may, for example, be disposed within the cleaning system so as to contact at least the first bevel-surface interface, the first bevel, and the apex of the substrate edge. The at least one second brush may, in certain embodiments, be disposed within the cleaning system so as to contact at least the second bevel-surface interface, the second bevel, and the apex. The at least one third brush may be disposed within the cleaning system so as to contact at least the first bevel, the second bevel, and the apex. Without wishing to be bound by theory, it is believed that the cleaning system disclosed herein demonstrates improved cleaning efficiency as compared to prior art systems employing a single straight brush, at least because the instant cleaning system employs a plurality of brushes arranged to roughly follow the contour of the beveled substrate edge.

In one embodiment, the plurality of brushes may be arranged such that the at least one first, second, and third brushes simultaneously contact the substrate edge (“simultaneous contact brush system”). Such an arrangement is illustrated in FIG. 2, which is a side view of an exemplary cleaning system 200 according to the instant disclosure. According to this non-limiting embodiment, a substrate edge 100 is conveyed across a cleaning system comprising a plurality of brushes. The plurality of brushes comprises a first brush 210, a second brush 220, and a third brush 230. Each brush comprises a plurality of bristles 240 and is connected to one of a plurality of fluid channels 250. A fluid 260 flows through the fluid channels 250, and travels through the bristles 240 to the substrate edge. The brushes 210, 220, and 230 simultaneously converge on the substrate edge. FIG. 2 does not illustrate at least one vibration generator attached to the cleaning system or at least one nozzle attached to at least one of the fluid channels; however one skilled in the art can easily envision such additional features as part of this embodiment. Other optional components, such as those discussed throughout the disclosure, may also be incorporated into the embodiment illustrated in FIG. 2.

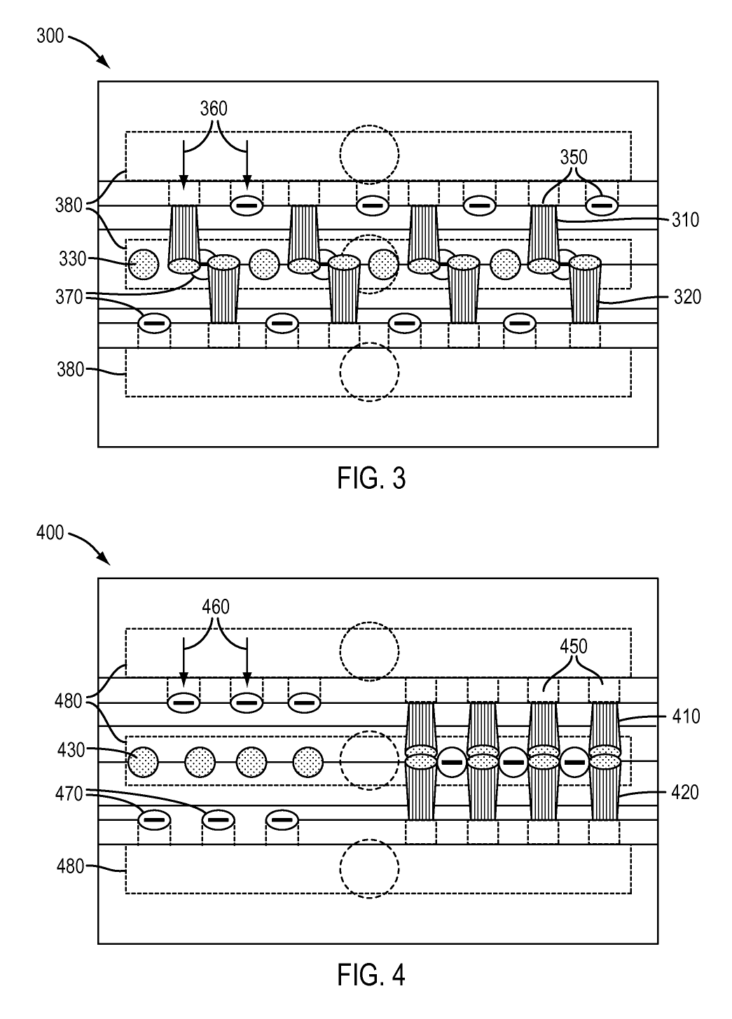

According to another embodiment, the plurality of brushes may be arranged such that each of the at least one first, second, and third brushes separately and sequentially contacts the substrate edge (“sequential contact brush system”). For instance, the substrate edge may sequentially first be contacted by the at least one first brush, then contacted with the at least one second brush, and finally contacted with the at least one third brush, or any variation thereof. FIG. 3 illustrates a cleaning system 300, employing this non-limiting embodiment.

The cleaning system 300 comprises at least one first brush 310, at least one second brush 320, and at least one third brush 330, each connected to a plurality of fluid channels 350. A fluid 360 flows through the fluid channels 350 and is delivered to the substrate edge either through the bristles of the at least one first, second, and third brushes, or through one or more nozzles 370. The fluid is supplied to the fluid channels by one or more fluid sources or reservoirs 380. As the substrate edge is conveyed through the cleaning system, it sequentially and separately comes into contact with each of the at least one first, second, and third brushes.

While the first and second brushes are labeled 310 and 320, respectively in FIG. 3, these labels are not meant to be limiting in any fashion and may be reversed without departing from the scope of the present disclosure. Other brush arrangements and brush orders can be envisioned by one skilled in the art, as desired for a particular application. Furthermore, while FIG. 3 does not illustrate at least one vibration generator connected to the cleaning system, one skilled in the art can readily envision such an additional feature as part of this embodiment. Other optional components, such as those disclosed herein, may also be incorporated into the embodiment disclosed in FIG. 3.

In a further embodiment, the plurality of brushes may be configured such that substrate is simultaneously contacted by two brushes and subsequently contacted by a third brush or a combination of brushes, or vice versa (“paired contact brush system”). For example, the substrate edge may first be simultaneously contacted by the at least one first and second brushes and subsequently contacted by the at least one third brush. Alternatively, the substrate edge may first be contacted by the at least one third brush and subsequently and simultaneously contacted by the at least one first and second brushes. In other embodiments, the substrate edge may sequentially come into contact with different pairs of brushes. By way of non-limiting example, the substrate edge may first be contact by at least one first and third brush and subsequently be contacted by at least one second and third brush. These arrangements may be modified in any fashion by changing which brushes are paired together so as to simultaneously contact the substrate edge. FIG. 4 illustrates a cleaning system 400, employing one variation of this non-limiting embodiment.

The cleaning system 400 comprises at least one first brush 410, at least one second brush 420, and at least one third brush 430, each connected to a plurality of fluid channels 450. A fluid 460 flows through the fluid channels 450 and is delivered to the substrate edge either through the bristles of the at least one first, second, and third brushes, or through one or more nozzles 470. The fluid is supplied to the fluid channels by one or more fluid sources or reservoirs 480. As the substrate edge is conveyed through the cleaning system, it sequentially first comes into contact with the at least one first and second brushes 410 and 420 and then comes into contact with the at least one third brush 430.

While the first and second brushes are labeled 410 and 420, respectively in FIG. 4, these labels are not meant to be limiting in any fashion and may be reversed without departing from the scope of the present disclosure. Other brush arrangements and brush orders can be envisioned by one skilled in the art, as desired for a particular application. Furthermore, while FIG. 4 does not illustrate at least one vibration generator connected to the cleaning system, one skilled in the art can easily envision such additional feature as part of this embodiment. Other optional features, such as those disclosed herein, may also be incorporated into the embodiment disclosed in FIG. 4.

These above-exemplified brush arrangements may be modified in any fashion by changing the order and/or pairings of the brushes. In further embodiments, the cleaning system comprises a plurality of sequentially arranged brush systems, which may be identical or different. For example, the cleaning system may comprise various sequences of simultaneous contact brush systems, paired contact brush systems, and sequential contact brush systems. The plurality of brushes may be arranged in any order and may differ from each other in any way, including the angles at which the first, second, and third brushes contact the substrate. It is within the ability of one skilled in the art to arrange the brushes within the cleaning system so as to achieve the desired cleaning effect without departing from the scope of the instant disclosure.

According to further embodiments, the plurality of brushes may be disposed within the cleaning system such that the brushes are capable of rotating, in clock-wise and/or counter-clockwise fashion. In these embodiments, any conventional spinning mechanism, such as a motor, may be operatively coupled to at least one of the plurality of brushes. According to various exemplary embodiments, the brushes may selectively spin as the substrate is conveyed across the cleaning system. Each of the plurality of brushes may spin in the same direction or in different directions.

Traditional methods for cleaning substrates rely solely on the mechanical action of the brush moving across the substrate to remove particles from the substrate edge. The cleaning system of the instant disclosure comprises at least one vibration generator, connected to the cleaning system, and configured to provide brush motion at sonic frequencies, so as to improve the effectiveness of the brushes in dislodging particles from the substrate edge. In certain embodiments, the vibration generator may be a sonic transducer. The at least one vibration generator provides sonic energy to at least the brushes, at a range of frequencies, which may be adjusted depending on the application. It is also within the ability of a skilled artisan to vary the amplitude and/or direction of vibration to suit a particular application.

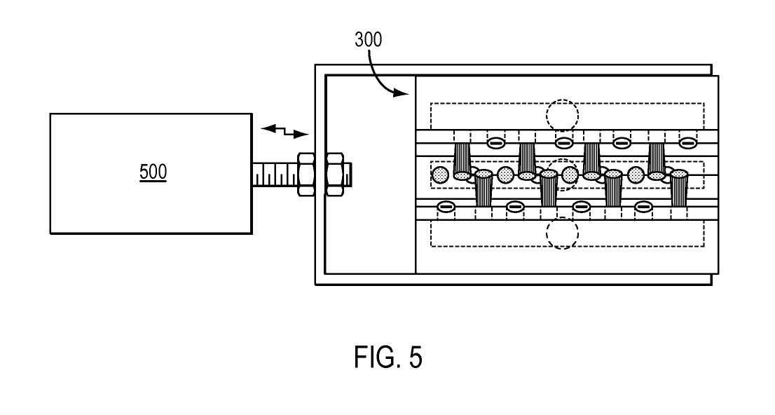

FIG. 5 illustrates one embodiment of the disclosure, in which a cleaning system 300 is attached to a vibration generator 500. While FIG. 5 illustrates the vibration generator 500 attached the cleaning system 300 of FIG. 3, it is to be understood that the vibration generator 500 may be attached to any cleaning system of the instant disclosure including, but not limited to, cleaning system 400, as illustrated in FIG. 4.

In certain embodiments, the frequency of the sonic energy may range from about 10 to about 1000 Hz, or from about 30 Hz to about 100 Hz, such as from about 200 Hz to about 500 Hz. By way of non-limiting example, the vibration generator may provide sonic energy at ultrasonic frequencies, in the kHz range or megasonic frequencies, in the MHz range. For example, commercially available megasonic transducers may provide frequencies approximating 1 MHz. Ultrasonic transducers may provide frequencies ranging, for example, from about 20 kHz to about 120 kHz.

According to other embodiments, the direction of the sonic vibration may be substantially parallel to the direction in which the substrate is conveyed. However, even in this embodiment, there may be a small percentage of vibration in other directions, such as directions normal and/or perpendicular to the direction in which the substrate is conveyed. Alternatively, the direction of the sonic vibration may be substantially perpendicular to the direction in which the substrate is conveyed. Likewise, there may be a small percentage of vibration in other directions, such as directions normal and/or parallel to the direction in which the substrate is conveyed.

The cleaning system may comprise a single generator, which is connected to the cleaning system and disposed to deliver sonic energy to at least one of the plurality of brushes disposed within the cleaning system. In this embodiment, each of the plurality of brushes will vibrate at substantially the same frequency. In other embodiments, the cleaning system may comprise more than one vibration generator connected to the cleaning system. It is within the ability of a skilled artisan to select any other configuration that will achieve the desired result for a particular application.

Also disclosed herein is an apparatus for cleaning at least one edge of a substrate, the apparatus comprising a cleaning system comprising (a) a plurality of fluid channels disposed within the cleaning system for delivering at least one fluid to the substrate edge, (b) a plurality of brushes comprising a plurality of bristles and/or nodules and connected to at least one of the plurality of fluid channels, (c) at least one nozzle disposed within the cleaning system, and (d) at least one vibration generator, connected to the cleaning system and disposed to deliver sonic energy to at least one of the plurality of brushes. It is to be understood that the cleaning systems employed in the methods disclosed herein and all the various embodiments related thereto are equally applicable to the apparatuses of the instant disclosure.

Various beneficial cleaning actions disclosed herein include, but are not limited to: (1) mechanical brushing of the substrate edge; (2) sonic action on the substrate edge; (3) chemical and/or solvent action on the particles; and/or (4) active particle removal. As the particles are loosened or dislodged from the substrate edge due to the brushing, sonication, chemical and/or solvent action, or any combination thereof, the particles may be actively removed from the substrate edge. Active particle removal is achieved through various mechanisms within the cleaning system including, but not limited to, mechanical action of the brushes and fluid flow from the fluid channels through the brushes and/or nozzles. Without wishing to be bound by theory, the substrate edge cleaning apparatuses and methods of the instant disclosure may function based on one or more actions described herein, which may work together to dislodge and actively remove particles from the substrate edge.

For instance, according to various non-limiting embodiments, as the substrate edge enters the cleaning system, the at least one vibration generator imparts sonic vibrations to the plurality of brushes. The mechanical and sonic brushing actions are focused in large part on three edge zones—the first bevel, the second bevel, and the apex, and optionally, the bevel-surface interfaces. At the same time, at least one fluid is introduced to the cleaning interface by the plurality of fluid channels. The fluid flows through the brushes and/or nozzles to the substrate edge. The combination of sonic brush vibration and chemical and/or solvent action serves to loosen and/or remove the particles from the substrate edge. The at least one fluid then serves to flush or otherwise remove the dislodged particles from the substrate, thereby lowering the probability that the particles will be redeposited on the substrate edge.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It is to be understood that the foregoing description is exemplary and explanatory only, and is not to be interpreted as restrictive of the disclosure. Moreover, it should be understood that various features and/or characteristics of differing embodiments herein may be combined with one another. Therefore modifications and variations may be made to the illustrative embodiments and other arrangements may be devised without departing from the spirit or scope of the invention. Since modifications combinations, sub-combinations, and variations of the disclosed embodiments incorporating the spirit and substance of the invention may occur to persons skilled in the art, the invention should be construed to include everything within the scope of the appended claims and their equivalents.

What is claimed is:

1. A method for cleaning at least one edge of a substrate, the method comprising:
conveying the substrate edge across a cleaning system comprising:
(a) a plurality of fluid channels disposed within the cleaning system and configured to deliver at least one fluid to the substrate edge;
(b) a plurality of brushes, each connected to at least one of the plurality of fluid channels and comprising a plurality of bristles and/or nodules;
(c) at least one nozzle, connected to at least one of the plurality of fluid channels; and
(d) at least one vibration generator connected to the cleaning system and disposed to deliver sonic energy to at least one of the brushes, and
contacting the substrate edge with the plurality of brushes and at least one fluid for a time sufficient to remove particles from the substrate edge;
wherein the substrate comprises a first surface and a second surface substantially parallel with the first surface;
wherein the substrate edge comprises a first bevel, a second bevel, and an apex between the first and second bevels; and
wherein the plurality of brushes is disposed within the cleaning system so as to contact at least the first bevel, the second bevel, and the apex of the substrate edge.

2. The method of claim 1, wherein the first surface and the first bevel are adjacently disposed so as to form a first bevel-surface interface, and the second surface and second bevel are adjacently disposed so as to form a second bevel-surface interface; and wherein the plurality of brushes comprises:
(a) at least one first brush disposed to contact at least the first bevel-surface interface, the first bevel, and the apex;
(b) at least one second brush disposed to contact at least the second bevel-surface interface, the second bevel, and the apex; and
(c) at least one third brush disposed to contact at least the first bevel, the second bevel, and the apex.

3. The method of claim 2, wherein the substrate edge simultaneously comes into contact with the at least one first, second and third brushes.

4. The method of claim 2, wherein the substrate edge simultaneously comes into contact with the at least one first and second brushes, and subsequently comes into contact with the at least one third brush.

5. The method of claim 2, wherein the substrate edge simultaneously comes into contact with the at least one third brush, and subsequently comes into contact with the at least one first and second brushes.

6. The method of claim 1, wherein the substrate is conveyed across the cleaning system at a speed ranging from about 1 m/min to about 25 m/min.

7. The method of claim 1, wherein the bristles and/or nodules of the plurality of brushes are chosen from the group consisting of nylon, polyvinyl acetate, urethane foam, and mohair bristles and/or nodules.

8. The method of claim 1, wherein the frequency of the sonic energy ranges from about 100 to about 500 Hz.

9. The method of claim 1, wherein the at least one fluid is chosen from the group consisting of water, deionized water, acids, bases, and surfactant solutions.

10. An apparatus for cleaning at least one edge of a substrate, the apparatus comprising a cleaning system comprising:
(a) a plurality of fluid channels disposed within the cleaning system and configured to deliver at least one fluid to the substrate edge;
(b) a plurality of brushes, each connected to at least one of the plurality of fluid channels and comprising a plurality of bristles and/or nodules;
(c) at least one nozzle, connected to at least one of the plurality of fluid channels; and
(d) at least one vibration generator connected to at least one of the plurality of brushes and disposed to deliver sonic energy to the brushes;
wherein the substrate comprises a first surface and a second surface substantially parallel with the first surface;
wherein the substrate edge comprises a first bevel, a second bevel, and an apex between the first and second bevels; and
wherein the plurality of brushes is disposed within the cleaning system so as to contact at least the first bevel, the second bevel, and the apex of the substrate edge.

11. The apparatus of claim 10, wherein the first surface and the first bevel are adjacently disposed so as to form a first bevel-surface interface, and the second surface and second bevel are adjacently disposed so as to form a second bevel-surface interface; and wherein the plurality of brushes comprises:
(a) at least one first brush disposed to contact at least the first bevel-surface interface, the first bevel, and the apex;
(b) at least one second brush disposed to contact at least the second bevel-surface interface, the second bevel, and the apex; and
(c) at least one third brush disposed to contact at least the first bevel, the second bevel, and the apex.

12. The apparatus of claim 11, configured such that the substrate edge simultaneously comes into contact with the at least one first, second and third brushes.

13. The apparatus of claim 11, configured such that the substrate edge simultaneously comes into contact with the at least one first and second brushes, and subsequently comes into contact with the at least one third brush.

14. The apparatus of claim 11, configured such that the substrate edge simultaneously comes into contact with the at least one third brush, and subsequently comes into contact with the at least one first and second brushes.

15. The apparatus of claim 10, wherein the bristles and/or nodules of the plurality of brushes are chosen from the group consisting of nylon, polyvinyl acetate, urethane foam, and mohair bristles and/or nodules.

16. The apparatus of claim 10, wherein the frequency of the sonic energy ranges from about 100 to about 500 Hz.

17. The apparatus of claim 10, wherein the at least one fluid is chosen from the group consisting of water, deionized water, acids, bases, and surfactant solutions.
